(19) United States
(12) Patent Application Publication
(10) Pub. No.: US 2010/0042528 A1
(43) Pub. Date: Feb. 18, 2010

(54) Method and system for financing and reimbursement of infrastructure and improvements to real property.

(76) Inventors: Gregory A. Youngs, San Antonio, TX (US); David L. Earl, San Antonio, TX (US)

Correspondence Address: Gregory A. Young;c/o Earl & Associates, P.C., 15303 Huebner, Bldg. #15, San Antonio, TX, 78248, US

(21) Appl. No.: 12/583,122

(22) Filed: Aug. 14, 2009

Related U.S. Application Data
(60) Provisional application No. 61/188,922, filed on Aug. 14, 2008.

(51) Int. Cl. G06Q 40/00

(52) U.S. Cl. 705/35

(57) ABSTRACT

A computer implemented method and system for financing and reimbursement of infrastructure and improvements to real property. The method results in the reimbursement of certain costs of infrastructure and improvements made to the land. These improvements could include utilities, streets and drainage among others. Data received via a wide area network from a client and multiple databases is processed, automatically generating and delivering via e-mail protocol or website access, proposals and financial projections unique to that client. The data is further processed generating a covenant or similar instrument recorded in the real property records. The instrument creates a lien running with the land obligating future owners to pay assessments for set period of time and or total dollar amount. Certain data bases are periodically accessed determining property ownership and values with the resultant information processed and calculated automatically, creating invoices for delivery via e-mail protocol and postal service.

### CROSS REFERENCES TO RELATED APPLICATIONS

This application claims the benefit under Title 35 United States Code §119(e) of U.S. Provisional Application 61/188,922 filed Aug. 14, 2008 the full disclosure of which is incorporated herein by reference.

### FEDERALLY SPONSORED RESEARCH

Not Applicable

### BACKGROUND

1. Field

This application generally relates to the field of real estate development financing. More specifically, an embodiment of the invention relates to a method and system to reimburse a real estate developer or landowner for the costs of certain infrastructure and improvements constructed for the benefit of the future owners of the improved property.

2. Background Information

Historically, a developer will make improvements to and install infrastructure within a tract of land, adding significant value to that land. The nature of these improvements include but are not limited to the installation of streets, roads, water and sewer lines, gas and electric lines, curbs, sidewalks, park improvements and other common areas, drainage improvements, and other costs associated with these improvements. The developer makes use of equity and or debt financing to effectuate these improvements with the intention of reselling all or parts of the property at a profit.

3. Discussion of Related Art

In a small minority of cases the developer may receive full or partial reimbursement of the infrastructure and related costs through a governmentally created “Improvement District” such as a “Public Improvement District”, “Revenue Allocation District” or “Municipal Utility District”, variations of which exist in every State. These districts are used by local governments to incentivize developers in order to stimulate development and economic growth in the community. These incentives and subsidies can be used to promote a particular type and location of development which fills a need of the community. Typically, owners of property within these districts pay an additional tax or assessment which is directed to the developer to reimburse certain infrastructure and related development costs. The future income generated through the use of this mechanism could be used to significantly reduce the developers cost associated with developing the land. As a result, the subsequent purchasers of the real property can benefit from lower initial pricing, and or the provision of enhanced or additional amenities.

While desirable, these arrangements are complex, time consuming and expensive to accomplish. And in most cases, due to a variety of reasons both political and statutory, these arrangements are simply not available to the vast majority of landowners and developers. The invention, system & method described herein provide an original solution to this problem.

### SUMMARY OF THE INVENTION

It is therefore an object of the present invention to afford a unique and novel computer implemented method and system for financing and reimbursing the costs related to infrastructure and other improvements made to real property. Implementation of the invention is a practical and desirable alternative to the creation of a similar improvement district by a governmental entity. Some of the advantages of this invention over the historically used methods include significantly lower cost of implementation, significantly shorter time frame for implementation and a substantially reduced time requirement for administrative tasks on the part of the developer or landowner.

It is a further object of the present invention to allow a prospective real estate developer or landowner to create an improvement district on a particular tract of land. The improvement district, through a fiduciary, then collects assessments from subsequent property owners within the geographical boundaries of the district. These boundaries will be described in the instrument creating the district, which is typically a covenant filed in the jurisdictions real property records.

The revenue from the assessments allow for the reimbursement of certain costs of infrastructure and related improvements made or to be made to a particular tract of land. These improvements could include water and sewer lines, gas and electric lines, streets, curbs and sidewalks, drainage improvements and other costs related to the development of the land. Data received via a network from the developer or landowner and the tax assessor collector and real property record data bases of the appropriate jurisdictions is automatically processed to generate, and deliver electronically, a detailed proposal and financial projections based on the developer or landowners development plans. By processing the data from these sources a document in the form of a declaration of covenants and restrictions or similar instrument is generated and recorded electronically in the real property records of the jurisdiction in which the subject real property is located. The recorded instrument creates a lien which runs with the land and obligates future owners to pay an assessment for a predetermined period of time and or until a predetermined dollar amount in assessments has been paid. The databases of the appropriate jurisdictions tax assessor and real property records offices are accessed on prescribed dates to identify the current property owner as well as the current assessed value of the property as determined by the tax assessor's office. This information is processed to calculate the appropriate assessment and automatically create invoices and statements delivered via e-mail protocol and postal service to the current property owners for payment. The revenue generated through assessments is distributed to the landowner or developer to reimburse a predetermined schedule of infrastructure and improvement related expenditures. Typically, a fiduciary or third-party intermediary will be used to implement the invention and distribute revenue according to an agreement executed between the fiduciary and the developer or landowner. At a time subsequent to the recordation of the instrument creating the district, the future revenue can be pledged or sold to generate current revenue to the developer or landowner to accelerate the payment of the reimbursements due. Other objects of the present invention will be made clear after reading the following description and consideration of the flowcharts and drawings attached hereto.

### DESCRIPTION OF THE DRAWINGS

FIG. 1 Illustrates a high level view of the relationships between databases, developer, landowner, client and fiduciaries network terminals.

FIG. 2 Illustrates the basic steps in the creation of an improvement district.

FIG. 3 Illustrates the determination of ownership, calculation of assessments and invoice generation.

FIG. 4 Illustrates the automated assessment collection process.

FIG. 5 Illustrates the basic steps involved in the implementation of the invention.

### DESCRIPTION OF THE PREFERRED EMBODIMENTS

So as to highlight the key components and embodiments of the present invention, the following detailed description uses the example of a residential subdivision as a paradigmatic case of the implementation of the invention. The following description indicates various embodiments of the invention as well as numerous specific details thereof. These embodiments and details are given by way of illustration and not of limitation. A number of modifications and or substitutions could be made within the scope of an embodiment of the invention, and the embodiments of the invention include any such modifications and or substitutions.

All steps in the process described which relate to the present invention are executed in the software installed on the fiduciaries hardware unless it is expressly stated that the step is to be taken by a human: staff member, developer, landowner, or other person. The software to execute these steps is known to one of ordinary skill in the art. Several databases, each of which contains several records with at least one data field per record, are employed. Some data fields serve as repositories for information as it is input by a human; other fields contain values which are assigned by a formula which references other fields as factors. As is evident to one skilled in the art, the databases are relational. The embodiments of the invention include but are not limited to the following:

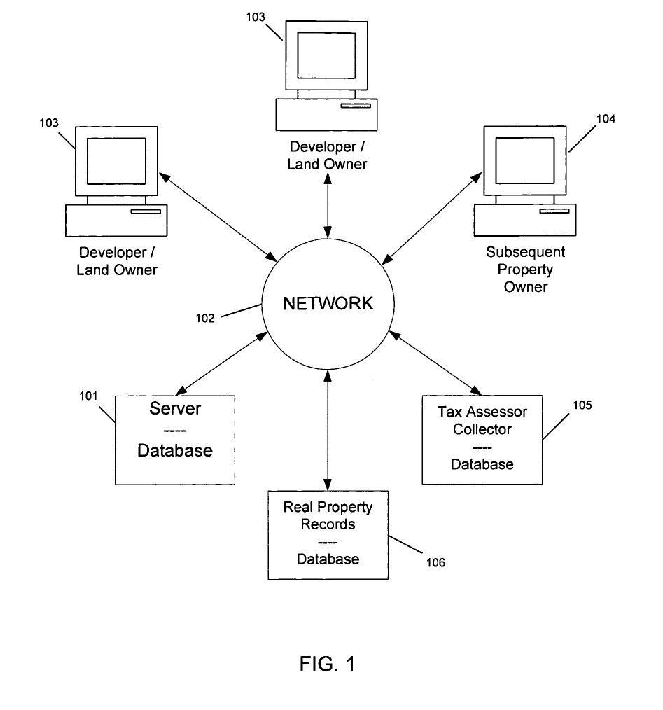

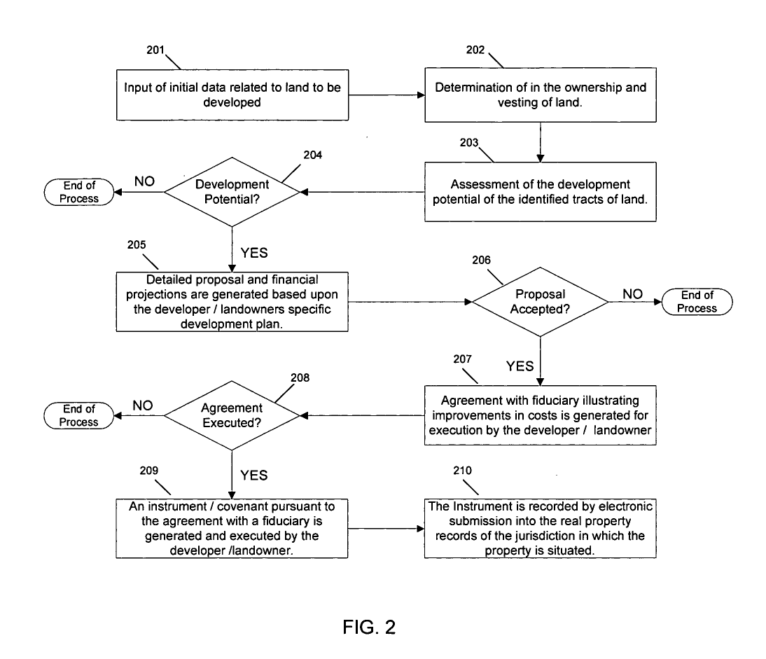

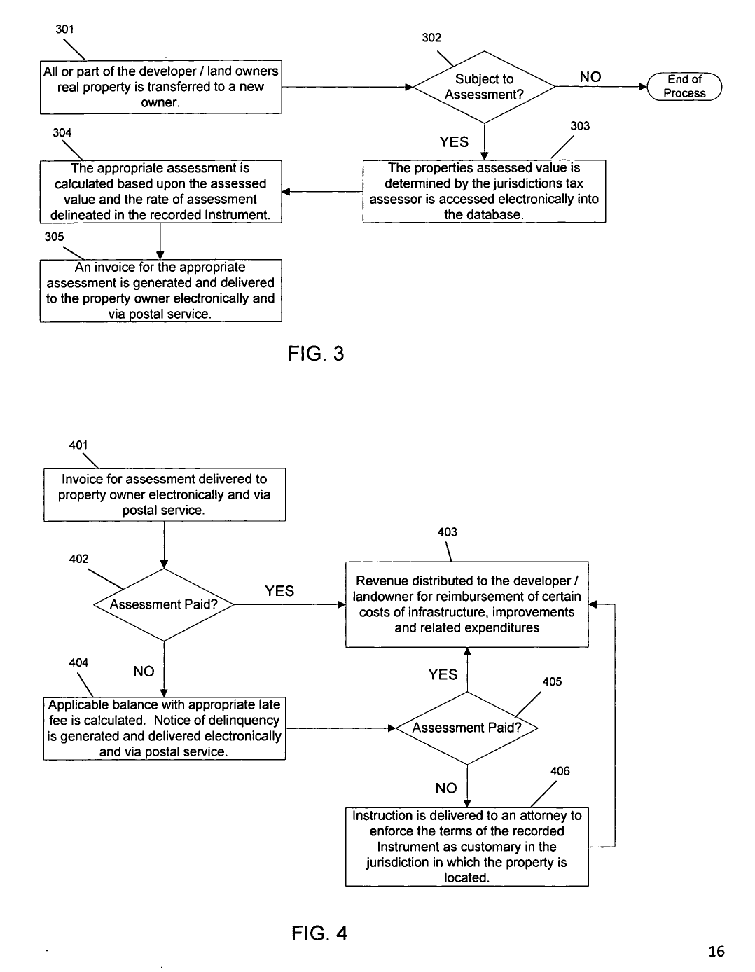

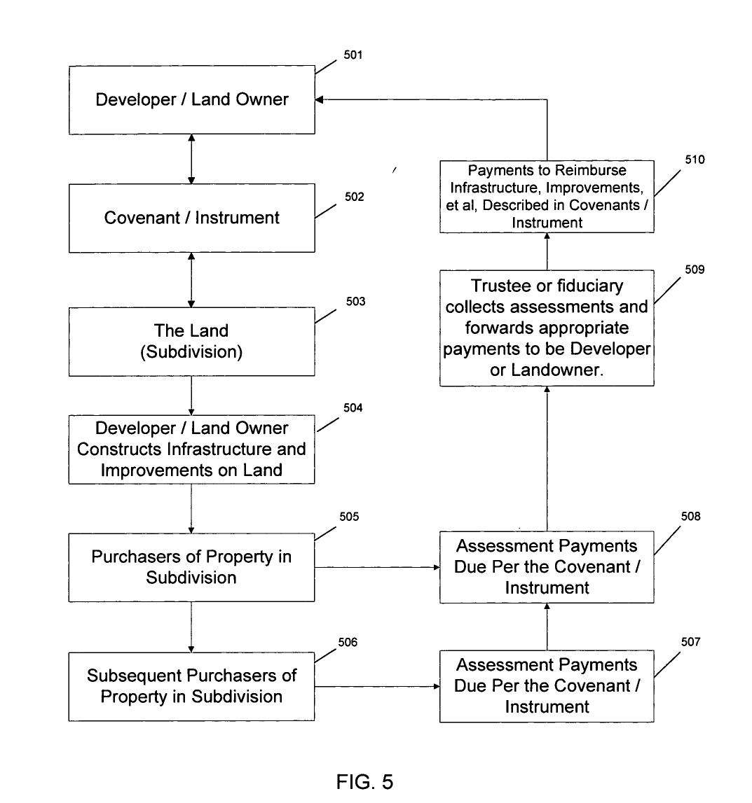

Reference is first made to FIG. 1 for a high level view of the relationships between databases, developer, land owner, client and fiduciaries network terminals. This illustration is not intended to be all-inclusive. Additional participants and databases may be included within the embodiments of the invention. In FIG. 2, steps 201, 202 and 203, the system must assemble and compile the relevant information required to make the automated analysis and evaluation of the development potential of an identified tract of land. This analysis is made by accessing and processing information collected from the developer or landowner 103 via input at a website or by e-mail protocol, in addition to information from certain other databases 105, 106.

The analysis 203 would include variables such as the costs associated with the design construction and installation of infrastructure and improvements to the specific tract of real property, including design, construction and installation of streets, roads, water and sewer lines, gas lines, electric lines, curbs, sidewalks, park improvements and other common areas, community centers, drainage improvements, and other expenditures which will benefit the future owners of the real property. Additional factors include assessment rates, current zoning, current total tax rate, lot size, finished value of improved property, and estimated build out time. The resultant data is automatically processed to generate a proposal and financial projections that are unique based on the data input. The proposal and financial projections 205 will then be delivered for review by the developer or landowner via e-mail protocol or by password-protected access to a website hosted on a server 101 containing the resultant information.

Upon acceptance of the proposal by the developer or landowner 206 the data compiled on the server 101 is automatically processed to generate a series of documents 207. The documents would include a financing agreement between the developer or landowner and a fiduciary to administer execution of the method of the invention. In addition the instrument creating the district, typically a declaration of covenants, conditions and restrictions, or similar document, will be generated 207. The documents 207 may be generated and displayed as an HTML document on a website or alternatively, converted into a portable document format for delivery to the developer or landowner via e-mail protocol. The documents will then be executed 208 by the developer or landowner, with the instrument/covenant creating the district recorded by electronic submission into the real property records 106 of the jurisdiction in which the property is situated.

Additional novel characteristics of the invention include (1) An instrument/covenant creating the district, typically a declaration of covenants, conditions and restrictions, (2) tied to and running with the land, (3) which shall apply to any divisions or subdivisions of the property, such as the original tract being subdivided into individual lots or any subsequent “recombining”, “replatting” or absorption into a larger tract of land, (4) includes a legal description such as, “Lots 1 through 261, within Example Subdivision in the City of Wendover, County of Smith, State of Nevada, said subdivision map being recorded as Document No. 123456 on or about Nov. 10, 2006 in the Smith County Recorder's Office, Smith County, Nevada.”, (5) includes a description of enforcement procedures and remedies for nonpayment of assessments, exemptions to assessments of any, (6) identifies and contact information for the fiduciary, trustee or other party responsible for oversight of the collection and enforcement of assessments, (7) and shall be binding on future owners of the land, (8) obligating said owners to pay annual assessments that shall be secured by a lien on the property, (9) payable to a specified beneficiary, trustee or fiduciary (10) who is identified with the accompanying contact instructions in the instrument (11) for a fixed number of years, typically 30 years, and or a predetermined total dollar amount, with the arrangement being dissolved upon first reaching the predetermined date or dollar amount specified in the instrument/covenant, (12) with said assessment being calculated as a percentage of the assessed value of the property or a fixed dollar amount, (13) as reimbursement for our certain infrastructure and improvements benefiting the land and future owners, (14) and may include language restricting future covenants or instruments that include charges, assessments or transfer and conveyance fees.

Examples of the benefits the developer or landowner may confer upon the land in exchange for the right to receive reimbursement include but are not limited to the following. (1) Improvements related to the design, planning and engineering of the land, (2) construction and installation of streets, roads, curbs and sidewalks, (3) water and sewer lines, (4) gas and electric lines, (5) drainage improvements, (6) park improvements and other common areas, (7) community centers, (8) solar, wind, geothermal or other shared energy generation facilities (9) and other features which are of benefit to subsequent property owners with the obligation to pay assessments.

It is contemplated that the total of all assessments or charges levied upon subsequent property owners shall not exceed the actual costs related to the design, construction and installation of streets, roads, water and sewer lines, gas and electric lines, curbs, sidewalks, park improvements and other common areas, community centers, drainage improvements, and certain other expenses which will benefit future owners of the real property along with a reasonable rate of interest to be paid thereon.

Variations made within the scope of an embodiment of the invention include:

(1) The use of assessments revenue to fund a variety of community initiatives or charitable endeavors that would directly benefit the property owners, the community or the region.
(2) The funding, in part or in whole of fire protection services, private security or police protection and other services which may be provided by a private or governmental entity but would benefit the real property.
(3) The amount of the assessment or charge may be a fixed dollar amount payable on a monthly, quarterly or annual basis. The assessment or charge may also be calculated as a fixed percentage of the value of the property as determined by the appraisal district responsible for determining the value of that specific property for the purpose of levying ad valorem taxes. The initial and continued valuation of a newly constructed property may be made using the sales price, lot size, square footage or other predetermined schedule in the absence of a valuation by a taxing authority or appraisal district. The assessment or charge shall not be in the form of a transfer fee or conveyance fee.
(4) Assessments and charges may be waived until such time as a home, commercial building or other permanent structure has been built on the land or at such time a predetermined date has been reached.
Assessments and charges may be deferred for a period of time after the initial sale of the property. For example, the initial assessment could be deferred for a 12 to 36 month period.
(5) This invention may be employed to lower the price required to construct an affordable housing subdivision. This is particularly true if the present value of the future income stream created by the instrument is converted into cash by means of a loan or a full or partial sale of the income stream to investors. This will allow for a lower initial lot pricing, and consequently, a lower finished home price.
(6) The assessments due under the terms of the instrument may be collected directly by the developer, landowner, or assigns. However it is contemplated that the collection and enforcement of the provisions of the instrument shall be undertaken by a trustee, escrow agent, fiduciary or an entity established specifically and exclusively for that task.
(7) The assessment revenue can be pledged to a lender or investor for a period of time as a credit enhancement and additional collateral securing funds lent or invested to make improvements to the land.
(8) The invention may be employed by as a loss mitigation tool by a lender having taken possession of a tract of land. The resultant revenue would reduce or eliminate any financial losses or deficiencies on the part of the lender.

### DEFINITIONS

“Developer”, “Landowner”, “Client” and “Declarant” shall refer to that person or entity owning and or making the improvements to the land. “Land” or Property” shall refer to real property. “Subsequent Property Owner” and “Future Property Owner” shall refer to the purchaser of real property currently or formerly owned by the developer or landowner. “Instrument” and “Covenant” shall refer to the document filed in the real property records which obligates subsequent property owners to pay assessments. “District” shall refer to a specific tract of land described in the instrument/covenant which obligates a subsequent owner to pay assessments. “Real Property Records” refers to the repository of real estate records maintained by the jurisdiction in which the property is located. “Assessed Value” refers to the value of the property as determined by the Tax Assessor Collector's Office. “Fiduciary”, “trustee”, or “escrow agent” refers to that person or entity responsible for the collection, enforcement and disbursement of assessment revenue.

What is claimed is:

1. A computer implemented method and system for financing and reimbursing the costs related to infrastructure and other improvements made to real property, the method comprising the steps of:
providing a database containing the relevant information related to the said developer, landowner, or more generally, clients property;
providing a template to said developer or landowner over a wide area computer network;
receiving information related to the property in the template, over said wide area computer network, said information comprising a description of the property and the planned improvements and infrastructure contemplated;
identifying the current ownership vesting of the land by automatically accessing external databases over said wide area computer network;
determining the status of existing entitlements and zoning of the land by automatically accessing external databases over said wide area computer network;
automatically generating a detailed proposal and financial projections based upon the combined data and input and delivering to the developer or landowner via e-mail protocol;
generating an instrument/covenant pursuant to the proposal and financial projections, which runs it with a land, and obligates future property owners to pay assessments to reimburse the developer or landowner for certain costs related to infrastructure and improvements made to the property for the benefit of said owners;
delivering said instrument/covenant over a wide area computer network to be filed electronically in the real property records of the jurisdiction in which the land is located;
processing and comparing the relevant data relating to said land to that data contained in the databases including the tax assessor collector and custodian of relevant real property records against the original data processed;
identifying any changes in ownership and assessed value which may have occurred via scheduled automated access of certain databases;
automatically processing the data from the relevant databases to identify the property owners subject to the assessments;
automatically calculate the appropriate assessment based on the data collected and processed from the appropriate databases;
automatically generate an invoice for the appropriate assessment for delivery via e-mail protocol and U.S. Postal Service;
receipt of assessment payments due and disbursement to the developer/landowner for reimbursement of certain costs pursuant to and referenced in the instrument/covenant;
automatically notify property owners being delinquent in the payment of assessments of the initiation of formal collection efforts;
provide relevant information regarding delinquent assessments from the database and deliver via e-mail protocol to an attorney to enforce the terms of the recorded instrument as customary in the jurisdiction in which the property is located;
receipt of assessment payments resulting from collection efforts for disbursement to the developer/landowner for reimbursement of certain costs pursuant to and referenced in the instrument/covenant.

2. The method of claim 1, wherein the developer/landowner obtains the right to receive assessment fees paid by subsequent owners.

3. The method of claim 1, wherein the instrument/covenant is recorded in the real property records of the jurisdiction in which the land is located prior to be transfer of the subject property to a subsequent owner.

4. The method of claim 1, wherein assessments shall be due from subsequent owners of the land and shall apply to any divisions or subdivisions of the property, such as the original tract being subdivided into individual lots or any subsequent recombining, replatting or absorption into a larger tract of land.

5. The method of claim 1, wherein prior to each transfer of property for the prospective purchaser is provided notice of the existence of the instrument/covenant by actual or constructive notice.

6. A method of claim 1, wherein the developer/landowners right to receive revenue from the assessments due may be assigned, sold or hypothecated.

7. A method of claim 1, wherein the developer/landowner pledges the future revenue from assessments to a lender or investor for a period of time as a credit enhancement and additional collateral to secure funding to acquire and make improvements to the land.

8. A method of claim 1, wherein a lender having taken possession of a tract of land through foreclosure employs the invention as a loss mitigation tool. The resultant revenue stream would reduce or eliminate any financial losses or deficiencies on the part of the lender.
